(19) United States
(12) Patent Application Publication
(10) Pub. No.: US 2008/0302618 A1
(43) Pub. Date: Dec. 11, 2008

(54) Hydraulic Coupling For An Actuating System For Actuating A Motor Vehicle Clutch

(75) Inventors: Boleslaw Tulaczko, Schonungen/Hausen (DE); Thomas Riess, Hassfurt (DE); Dieter Gebauer, Euerbach (DE); Andre Gemeinhardt, Obereuerheim (DE); Holger Wegner-Braun, Geldersheim (DE); Roland Morber, Sulzfeld (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/156,751

(22) Filed: Jun. 4, 2008

(30) Foreign Application Priority Data
Jun. 6, 2007 (DE) 10 2007 026 427.7

(51) Int. Cl. F16F 7/00

(52) U.S. Cl. 188/266

(57) ABSTRACT

Presented is a hydraulic coupling for an actuating system for actuating a motor vehicle clutch. The hydraulic coupling includes a socket part defining an internal recess, a plug part configured for insertion into the socket part, a locking element that engages with the plug part and the socket part in an assembled state of the hydraulic coupling and which holds the plug part and the socket part captively together, a damping element that is configured for damping undesirable vibrations, with the damping element being supported on the locking element, and a support element disposed between the damping element and the locking element and extending around the entire circumference of the damping element.

### BACKGROUND OF THE INVENTION

1. Field of the Invention

The invention relates to a hydraulic coupling for an actuating system for actuating a motor vehicle clutch.

2. Description of the Related Art

A typical hydraulic coupling that is designed to prevent, or at least effectively to reduce, the transmission of the axial vibrations emanating from the internal combustion engine of a motor vehicle to the vehicle's driver and to the vehicle's passengers is disclosed in DE 103 52 943 A1. In this hydraulic coupling, the plug part is arranged with freedom of axial displacement with respect to the socket part in opposition to the action of a damping element in the form of an elastomeric part, where the damping element can be supported on a locking member directly adjacent to the damping element and also on the socket part. This hydraulic coupling can considerably reduce both the propagation of the structure-borne vibrations introduced by the internal combustion engine and the resulting pressure pulsations of the hydraulic system, and thus noticeably increases the driving comfort.

However, a disadvantage of this arrangement is that an improperly positioned damping element can interfere with the installation of the locking element. The assembly process can thus become cumbersome. Further, when the hydraulic coupling is under operating pressure, the local pressure per unit area being exerted on the damping element by the basically tangential action of the locking element on essentially two circumferential points of the damping element is extremely high. As a result, the locking element can dig itself into a damping element made of elastomeric material and ultimately reduce or even completely destroy its effectiveness.

### SUMMARY OF THE INVENTION

In one aspect, the invention involves a hydraulic coupling for an actuating system for actuating a motor vehicle clutch. The hydraulic coupling includes a socket part defining an internal recess, a plug part configured for insertion into the socket part, a locking element that engages with the plug part and the socket part in an assembled state of the hydraulic coupling and which holds the plug part and the socket part captively together, a damping element that is configured for damping undesirable vibrations, with the damping element being supported on the locking element, and a support element disposed between the damping element and the locking element and extending around the entire circumference of the damping element.

By means of the support element, the damping element is initially held securely in position during the assembly of the hydraulic coupling, and the necessary assembly space is kept free to allow the easy insertion of the locking element. When the hydraulic coupling is under pressure, the support force acting on the damping element is transmitted to the damping element via the support element. Further, because of the way in which the support element is designed, the pressure per unit area acting on the damping element is considerably reduced.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained below by way of example on the basis of the following description of the figures.

FIG. 1 is an illustrative schematic diagram of a hydraulic actuating device for actuating a motor vehicle clutch, according to one embodiment of the invention.

FIG. 2a is an illustrative diagram of a hydraulic coupling with a support element and a separate damping element, according to one embodiment of the invention.

FIG. 2b is an illustrative perspective view of a ring-shaped support element, according to one embodiment of the invention.

FIG. 3 is an illustrative diagram of a hydraulic coupling with a support element and a damping element formed as an integral part of a sealing element, according to one embodiment of the invention.

### DETAILED DESCRIPTION OF THE PRESENTLY PREFERRED EMBODIMENTS

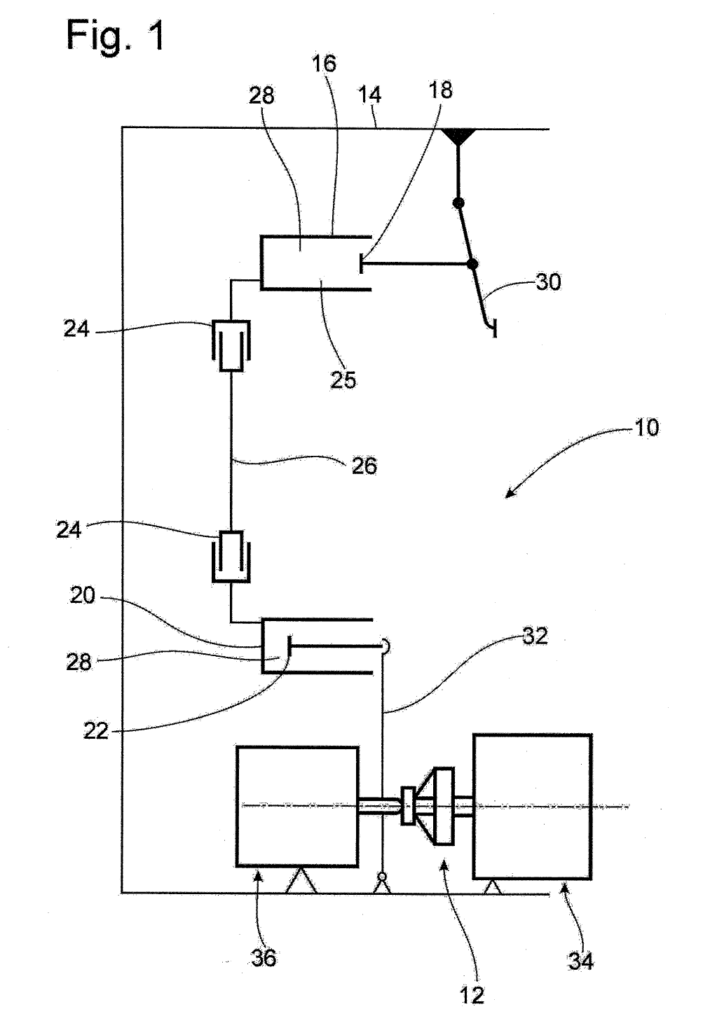

Referring to FIG. 1, a schematic diagram of a hydraulic actuating device 10 for actuating a motor vehicle clutch 12 is shown. The hydraulic actuating device 10 is mounted on a chassis 14 of a motor vehicle. Further, a master cylinder 16 with a piston 18 and a slave cylinder 20 with a piston 22 are provided, which are connected to each other by hydraulic couplings 24 and a hydraulic line 26 filled with a fluid 25 and which together form a common pressure space 28. The piston 18 of the master cylinder 16 is actuated by a pedal 30, whereupon the piston 22 of the slave cylinder 20 moves and thus controls a clutch fork 32, which disengages the clutch 12 on a prime mover such as an internal combustion engine 34. The clutch 12 is connected on the input side to the takeoff shaft of the internal combustion engine 34 and on the output side to a shift transmission 36.

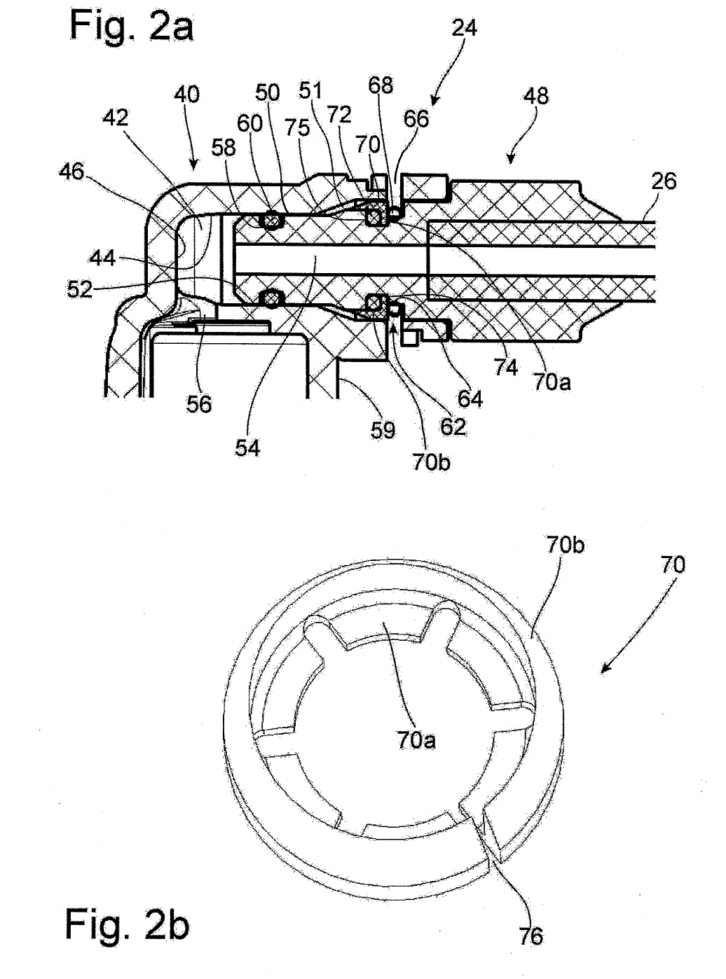

Referring to FIG. 2a, a hydraulic coupling 24, which serves simultaneously to damp structure-borne vibrations and to damp pressure pulsations in the hydraulic actuating system (FIG. 1) is shown. The hydraulic coupling 24 includes a housing-like cylindrical socket part 40 with a graduated cylindrical internal recess 42, which has an inside circumferential surface 44 and a bottom surface 46. In the recess 42 there is a corresponding, also cylindrically graduated, plug part 48 with an outside circumferential surface 50 of graduated diameter, a conical transition area 51, and an end surface 52. In the socket part 40 and in the plug part 48 are channels 54, 56, which, after the parts 40, 48 have been assembled, create a flow connection for a fluid present in the hydraulic system. The plug part 48 in FIG. 2a is designed as a component of a hydraulic line 26, whereas the socket part 40 is formed as an integral part of a housing 59 of a hydraulic actuating cylinder.

To produce a fluid-tight connection between the parts 40 and 48, a ring-shaped groove 58 is disposed in the axially forward section of the plug part 48. This groove holds a sealing element 60, preferably an O-ring seal of elastomeric material with vibration-damping properties, which is supported under pretension against the inside circumferential surface 44.

The hydraulic coupling 24 also includes an anti-separation device 62, which, in the assembled state, prevents the parts 40, 48 from coming apart unintentionally. For this purpose, a ring-shaped groove 64 of graduated diameter is provided in the plug part 48 and is accessed via slot 66. A locking element 68 made of round spring steel wire is snapped into the ring-shaped groove 64 via slot 66 after the locking element 68 has been first briefly expanded. The locking element 68 is supported axially on one side against the side of the wall of the groove 64 closer to the hydraulic line 26 and radially against the socket part 40, whereas, on the other side, the locking element 68 is supported against a disk section 70a of a ring-shaped support element 70 made of plastic.

The support element 70 is introduced jointly with a damping element 72 in the form of an elastomeric ring into a section of the groove 64 offset from the locking element 68 and supports itself there against a shoulder 74 of the groove 64.

Referring to FIG. 2b, a perspective view of the support element 70 is shown. The disk section 70a is of segmented design, and both the disk section 70a and a tubular section 70b are interrupted at one point by a slot 76, which is expanded for assembly purposes. The support element 70 is preferably made of a material, which is harder than that of the damping element, such as a stretchable plastic or metallic material.

As shown in FIG. 2a, the tubular section 70b rests on the inside circumference of the socket part 40, while the disk section 70a rests on the outer circumferential surface 50 of the plug part 48. The outside diameter of the support element 70 is selected in such a way with respect to the inside diameter of the socket part 40 that the parts 40, 48 are centered with respect to each other.

When the plug part 48 is installed, the damping element 72 is first placed in the groove 64, and then the support ring 70 is clipped onto the shoulder 74, so that the support ring 70 holds the damping element 72 reliably in place against the wall 75 (on the left in FIG. 2a) of the groove 64 and keeps the assembly area intended for the locking element 68 free. As a result, during the installation of the hydraulic coupling 24 in a vehicle, that is, upon introduction of the hydraulic line 26 into the master cylinder 16 and/or into the slave cylinder 20, it is guaranteed that the locking element 68 is introduced reliably.

In the case of a pressure build-up generated in the hydraulic actuating system shown in FIG. 1 by an actuation of the motor vehicle clutch 12, the plug part 48 shifts position slightly in the axial direction under compression of the damping element 72. When a pressure pulsation propagates through the hydraulic system, the hydraulic coupling 24 is also able to execute a corresponding change in its uptake volume by means of a short and reversible axial displacement of the plug part 48 and the socket part 40 with respect to each other, which has the effect of counteracting (i.e., absorbing) the pressure pulsation. When sound-absorbing materials are selected for the damping element 72 and the support ring 70, the structure-borne vibrations emanating from an internal combustion engine of the motor vehicle is almost completely eliminated or at least significantly attenuated.

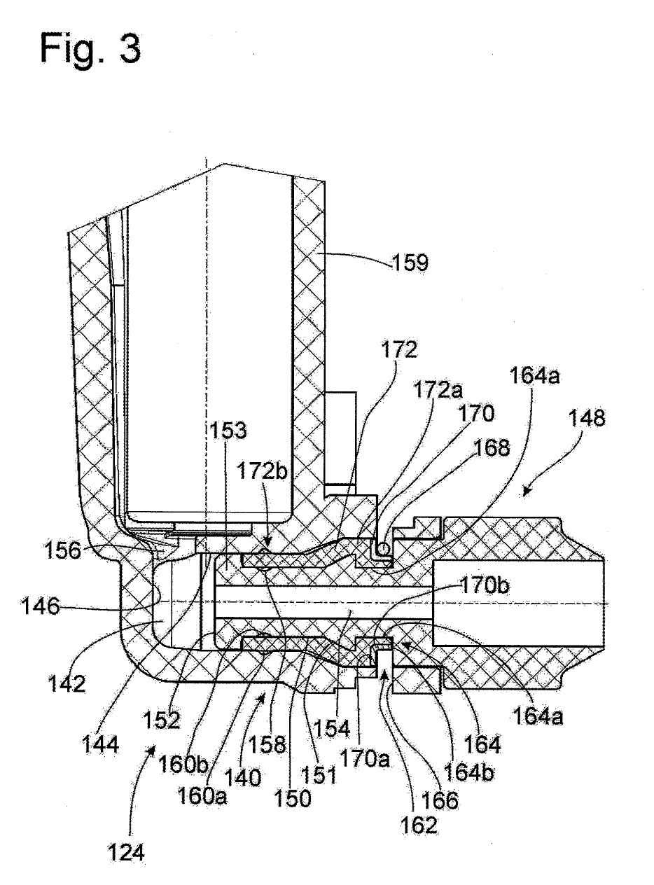

Referring to FIG. 3, another exemplary embodiment of a hydraulic coupling 124 is shown. This embodiment is identical in design and function to the embodiment shown in FIG. 2a except for the special features of the plug part 148 described in detail below. Reference characters in FIG. 3 add 100 to reference characters of similar elements in FIGS. 1 and 2a. Only the differences between the two embodiments are discussed below.

The damping element 172 shown in FIG. 3 is again made of elastomeric material. However, in this embodiment, damping element 172 is in the form of a hose, which is held in place on the plug part 148 by a terminal section 172a, which fits into a ring-shaped groove 164. The other terminal section 172b has an outer ring-shaped sealing bead 160a, which cooperates with the inner circumferential surface 144 of the socket part 140 and an inner, also ring-shaped, sealing bead 160b, which engages in a circumferential groove 158 in the plug part 148. In the area of the end surface 152, the plug part 148 is designed with a ring-shaped collar 153, against which the damping element 172, the diameter of which matches that of the collar, rests axially. Within the groove 164, the damping element 172 extends across the groove base 164a to the wall 164b, where a free space remains, also in the form of a groove. A support element 170 in the form of an angle ring is laid in this free space in such a way that its axial shank 170b rests against the groove wall 164b and its radial shank 170a rests against a shoulder of the damping element 172. During the assembly of the hydraulic coupling 124, therefore, the locking element 168 is easily introduced into the groove area. As a result of the large surface area of the damping element 172, the transmission of annoying vibrations from the plug part 148 to the socket part 140 are reduced even more effectively.

In another embodiment, instead of a separate damping element 70, 170 as shown in FIGS. 2a and 3, the damping element is produced as an integral part of the plug part or the socket part by means of, for example, injection molding. The inventive hydraulic coupling, furthermore, is also disposed between two sections of hydraulic line 26 or generally between any two desired components of a hydraulic actuating system.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hydraulic coupling for an actuating system for actuating a motor vehicle clutch, comprising:
a socket part defining an internal recess;
a plug part configured for insertion into the socket part;
a locking element that engages with the plug part and the socket part in an assembled state of the hydraulic coupling and which holds the plug part and the socket part captively together;
a damping element configured for damping undesirable vibrations, the damping element being supported relative to the locking element; and
a support element disposed between the damping element and the locking element and extending around an entire circumference of the damping element.

2. The hydraulic coupling according to claim 1, wherein the support element is supported on the damping element and on the plug part or the socket part.

3. The hydraulic coupling according to claim 1, further comprising a sealing element formed as an integral part of the damping element.

4. The hydraulic coupling according to claim 1, wherein a section of the support element extends axially over the damping element.

5. The hydraulic coupling according to claim 1, wherein the damping element formed as an elastomeric part and is supported on the locking element and the socket part or on the plug part.

6. The hydraulic coupling according to claim 1, wherein the support element comprises a material that is harder than the material of which the damping element is comprised.

7. The hydraulic coupling according to claim 6, wherein the support element comprises a plastic or a metallic material.
